(19) United States
(12) Patent Application Publication
(10) Pub. No.: US 2007/0214422 A1
(43) Pub. Date: Sep. 13, 2007

(54) Framework for implementing skins into a portal server

(75) Inventors: Sanjeev Kumar Agarwal, Alwar (IN); Deepak Kumar Goyal, Shivpuri (IN); Rahul Lalchand Shah, Borivali (IN)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/369,514

(22) Filed: Mar. 7, 2006

(51) Int. Cl. G06F 3/00

(52) U.S. Cl. 715/744; 715/716

(57) ABSTRACT

A method for user interface customization in a portal server that includes receiving a selection of a skin, wherein the skin comprises a plurality of files, customizing representation of content in each of a plurality of channels by using the plurality of files to obtain a customized user interface, wherein the content in each of the plurality of channels is obtained by the portal server, and outputting the customized user interface of the portal server.

### BACKGROUND

The Internet includes a large network made up of a number of smaller networks located worldwide, which are used by individuals, commercial institutions, academic institutions, governmental entities, and other endeavors. The world wide web, sometimes referred to as “the web” and well known by its initials in the “www” prefixes of many web addresses, includes an Internet-based facility that links documents across remote and local distances.

A “web page” includes a world wide web (e.g., web) document, which is a coded text file. An address on the Web (or on another Internet facility) is called a Uniform Resource Locator (URL), and defines the route across the Internet to a particular file, such as a web page. A web site includes a server computer (server) containing web pages and other files and strives to be continuously online to the Internet.

Portals function as web supersites that provide users with various services. Such services may include email, web searching, online shopping, news, directories (such as white and yellow pages functionalities), discussion groups, and links to other sites, among others. Portals organize information thereon into channels, sometimes referred to as “portlet windows.” The information for a channel is provided by a provider, which is sometimes referred to as a portlet.

Channels can be devoted to or concentrated towards a particular type of information content and may describe the browser window and the information behind it. For instance, channels exist on major portals for bookmarks, email, news headlines, stock quotes, sports scores, etc. Bookmarks provide functionality where the addresses (e.g., URL) of certain web sites are stored for quick and handy access by a user to a favorite or frequently used (e.g., visited) web site, which can save the user time and effort.

Often a user of the portal server seeks to customize the portal with respect to how the information is displayed. When customizing a user interface in a portal server, a user may change the theme of the user interface. A theme defines a background color or pattern, a font color, and a border color of the portal. Accordingly, when a user changes the theme, the user is able to customize the experience with the portal server by changing the background color or pattern, font color, and border color accordingly.

### SUMMARY

In general, in one aspect, the invention relates to a method for user interface customization in a portal server that includes receiving a selection of a skin, wherein the skin comprises a plurality of files, customizing representation of content in each of a plurality of channels by using the plurality of files to obtain a customized user interface, wherein the content in each of the plurality of channels is obtained by the portal server, and outputting the customized user interface of the portal server.

In general, in one aspect, the invention relates to a computer usable medium having computer readable program code embodied therein for causing a computer system to execute a method for user interface customization in a portal server that includes receiving a selection of a skin, wherein the skin comprises a plurality of files, customizing representation of content in each of a plurality of channels by using the plurality of files to obtain a customized user interface, wherein the content in each of the plurality of channels is obtained by the portal server, and outputting the customized user interface of the portal server.

In general, in one aspect, the invention relates to a system for user interface customization in a portal server that includes a skin framework configured to receive a selection of a skin, wherein the skin comprises a plurality of files, and customize representation of content in each of a plurality of channels by using the plurality of files to obtain a customized user interface, wherein the content in each of the plurality of channels is obtained by the portal server. The system further includes a renderer configured to output the customized user interface of the portal server.

Other aspects and advantages of the invention will be apparent from the following description and the appended claims.

### BRIEF DESCRIPTION OF DRAWINGS

FIG. 1 shows a schematic diagram of a system for user interface customization in a portal server in accordance with one or more embodiments of the invention.

FIG. 2 shows a schematic diagram of a skin framework for user interface customization in a portal server in accordance with one or more embodiments of the invention.

FIG. 3 shows a flow diagram of a method for creating a skin for user interface customization in a portal server in accordance with one or more embodiments of the invention.

FIG. 4 shows a flow diagram of a method for user interface customization in a portal server in accordance with one or more embodiments of the invention.

FIGS. 5A-5D show an example of user interface customization in a portal server in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and apparatus for customizing a user interface in a portal server. A portal server corresponds to a supersite that provides users with various services. An example of a portal server is a Sun JAVA™ System portal server (JAVA is a trademark of Sun Microsystem, Inc. based in Santa Clara, Calif. USA).

Specifically, embodiments of the invention allow for changing skin in a portal server. A skin defines how the content of the portal is displayed. Specifically, a skin defines a set of graphics, a layout of channels, font color and type, and the content that is displayed. For example, whereas a theme may only change the font color of the words “Check Mail”, a skin may change the words “Check Mail” to a graphical icon of an envelope. Further, when changing a skin, the appearance of the user interface changes, without changing the functions available with the portal.

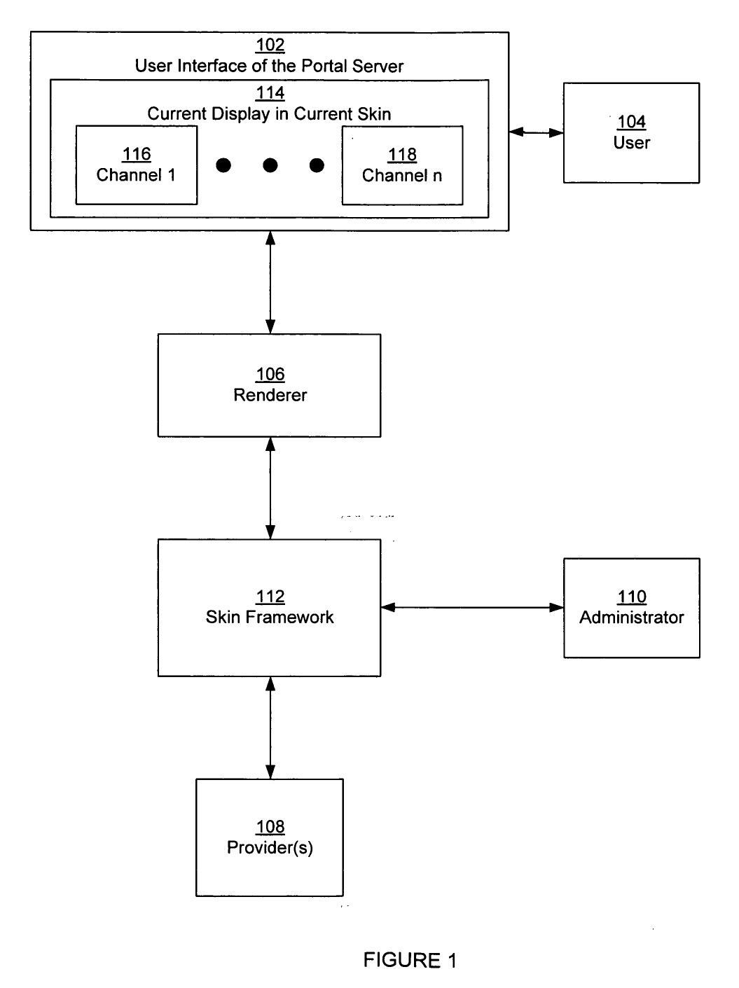

FIG. 1 shows a schematic diagram of a system for user interface customization in a portal server in accordance with one or more embodiments of the invention. As shown in FIG. 1, the system includes a user (104), a user interface of the portal server (102), a renderer (106), one or more providers (108), an administrator (110), and a skin framework (112). Each of these components is described below.

A user (104) corresponds to any person or program that interacts with a portal server (102). A user (104), in one or more embodiments of the invention may be a part of a group. For example, a portal server may be designed for a company and a user may be an employee of the personnel department of a company (not shown). In such scenario, the user (104) may be a part of the personnel group in the portal server (102). Thus, the user (104) may have access to the content associated with the personnel group.

The user interface of the portal server (102) corresponds to a collection of internet pages (not shown) that a user (104) may access from the portal server (102). For example, the user interface of the portal server (102) may include a skin selection page, a help page, an options page, and a home page. The skin selection page corresponds to an Internet page that allows a user (104) to select which skin should be used in the user interface. The help page of the user interface interacts with the user (104) to provide answers to any questions a user (104) may have. The options page allows a user (104) to adjust settings of the portal server (102). The home page corresponds to the initial page that a user (104) interacts with once the user (104) is logged into the user's account of the portal server (102). Accordingly, one of the internet pages corresponds to the current display in the current skin (114).

The current display in the current skin (114) corresponds to the internet page currently viewable by the user (104). The current skin is the skin selected to be used by the user (104). The current skin may correspond to a default skin or to a skin that the user (104) has chosen to customize the user interface of the portal server (102).

The current display in the current skin (114) includes multiple channels (e.g., channel 1 (116), channel n (118)). In accordance with one or more embodiments of the invention, a channel (e.g., channel 1 (116), channel n (118)) corresponds to a space, such as a box, in the user interface that is dedicated to a particular type of information content. Specifically, the current display in the current skin (114) corresponds to a web page divided into a dynamic table (not shown) in accordance with one or more embodiments of the invention. At least one of the boxes defined by the dynamic table corresponds to a channel (e.g., channel 1 (116), channel n (118)). The type of information content for a channel (e.g., channel 1 (116), channel n (118)) may correspond to such items as online shopping, bookmarks, web searching, email, news headlines, stock quotes, sports scores, as well as virtually any other content obtainable from the Internet.

Those skilled in the art will appreciate that when the current display in the current skin corresponds to an internet page used for administrative purposes (e.g., help page, skin selection page, and other such administrative pages), then no channels are displayed, rather only the administrative information is displayed.

Continuing with FIG. 1, a renderer (106) is connected to the user interface of the portal server (102). The renderer (106) includes functionality to obtain an internet page corresponding to the current display in the current skin (114) and output internet page so that the internet page is viewable by the user (104).

The system, as shown in FIG. 1, also includes an administrator (110). The administrator (110) corresponds to a special type of user with administrative privileges to modify the portal server. The administrator (110) may modify the portal server for all users or for a particular group of users (described above). Specifically, the administrator (110) includes functionality to create new skins and to define the content for the channels (e.g., channel 1 (116), channel n (118)).

A provider (108) corresponds to a component that includes functionality to provide content for a channel (e.g., channel 1 (116), channel n (118)). Specifically, a provider (108) may correspond to a piece of software that link to a third party web page, a directory server or database that gathers content. Typically, a provider (108) provides only a single type of information content. Thus, an email provider (108) provides content about to email related items (e.g., an inbox) and a stock service provider provides content about stocks (e.g., a stock quote).

A skin framework (112) is connected to the renderer (106), administrator (110), and provider(s) (108). In one or more embodiments of the invention, the skin framework corresponds to a software package that includes functionality to perform any calculations required to update the skin. Specifically, the skin framework (112) includes functionality to query provider(s) for content and interact with an administrator for configuration information.

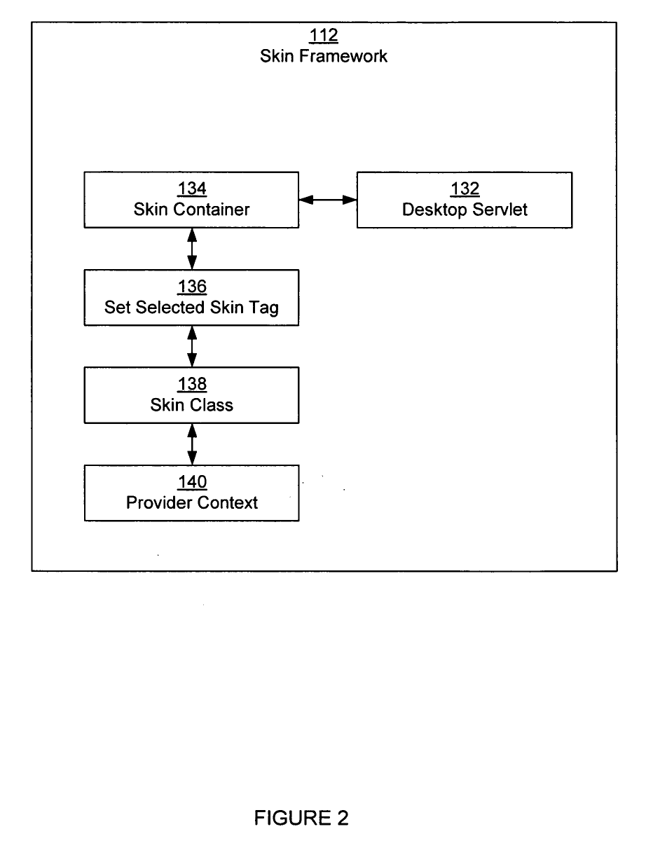

FIG. 2 shows a schematic diagram of a skin framework (112) for user interface customization in a portal server in accordance with one or more embodiments of the invention. In one or more embodiments of the invention, the skin framework (112) uses an object-oriented language. Specifically, the skin framework includes a set of classes and objects. However, those skilled in the art will appreciate that other types of computer languages, such as procedural languages, scripted languages, and other types of languages may also be used. As shown in FIG. 2, the skin framework (112) includes a desktop servlet (132), a skin container (134), a set selected skin tag (136), a skin (138), and a provider context (140). Each of these components is described below.

The desktop servlet (132) corresponds to a class that includes functionality to route user requests for content and processing to and from providers and users, pass provider specific objects between the user and provider, obtain editable content from the provider, and perform administrative tasks, such as logout, switch to help screen, and switch to the skin selection page (not shown).

The skin container (134) corresponds to a logical entity that includes functionality to allow a user to change the skin. In general, a container (not shown) corresponds to a logical entity that contains the content of a single channel (described in FIG. 1) and any decorative or descriptive elements, such as banners and menu bars. Specifically, a container can be used to provide a home page or display a channel as a full page. Accordingly, a skin container (134) corresponds to a container for the skin selection page in one or more embodiments of the invention.

Specifically, in one or more embodiments of the invention, the currently selected skin of the user is set as an attribute in a data repository (not shown), such as a directory server, database, or other type of storage unit for data. In such embodiments, the skin container (134) allows a user to change the skin without administrator involvement. Further, when Java Server Pages (“JSPs”) Providers are used, the skin container (134) corresponds to an instantiation of the JSPSingleContainerProvider class, developed by Sun Microsystems and set of JSPs in accordance with one or more embodiments of the invention. Those skilled in the art will appreciate that other programming languages that allow for the functionality provided by the skin container (134) may also be used.

Continuing with FIG. 2, the skin container (134) is connected to a set selected skin tag (136) in accordance with one or more embodiments of the invention. The set selected skin tag (136) corresponds to a custom tag library class that is used to generate the skin selection page. Specifically, the set selected skin tag (136) includes functionality to determine a group associated with the user and only display the optional skins for the group.

Further, in one or more embodiments of the invention, the set selected skin tag (136) includes functionality to process the skin selected by the user and create the current skin. Specifically, in one or more embodiments of the invention, set selected skin tag (136) includes functionality to determine how to output a customized user interface from a collection of web files (e.g., extensible markup language (XML) files, JSPs, hypertext markup language (HTML) files, etc.), image files, and other such files.

In one or more embodiments of the invention, a web file may specify the position of the channels, fonts to use, and how the different channels are to be displayed. For example, the web file may specify that a channel from provider X should be in the top left corner using a certain font and font color within a specific shape (i.e., oval or tabular form) and how the channel content obtained from provider X should be displayed (e.g., Stock quotes from provider X should be in bold center and weather from provider X in the top corner of the channel).

The image files correspond to images for the skin. Specifically, image files may exist for buttons, email icons, alphanumeric characters, functions (i.e., close, open), background, and shapes of channels, and other such images. The image files may be different for each skin. For example, a skin may have a different set of images for buttons, email icons, alphanumeric characters, functions (i.e., close, open, etc.), background, shape of channels, and other such objects, than any other skin.

Continuing with FIG. 2, the set selected skin (136) is connected to a skin class (138). The skin class (138) includes functionality to find the files associated with a skin selected by the user. Further, the skin class (138) includes functionality to directly modify an attribute in the data repository (described above) for a user in accordance with one or more embodiments of the invention.

The skin class (138) is connected to the provider context (140). The provider context (140) corresponds to an object in accordance with one or more embodiments of the invention. The provider context (140) includes information about the content of channel. Specifically, the provider context (140) is generated by communication with a provider (described in FIG. 1). Further, the provider context (140) may also define channel properties, such as a title and description.

Those skilled in the art will appreciate that while FIG. 2 describes only a few embodiments of the invention in which classes are used in the framework, other types of programming languages that do not rely on classes may also be used to allow for user interface customization in a portal server with skins.

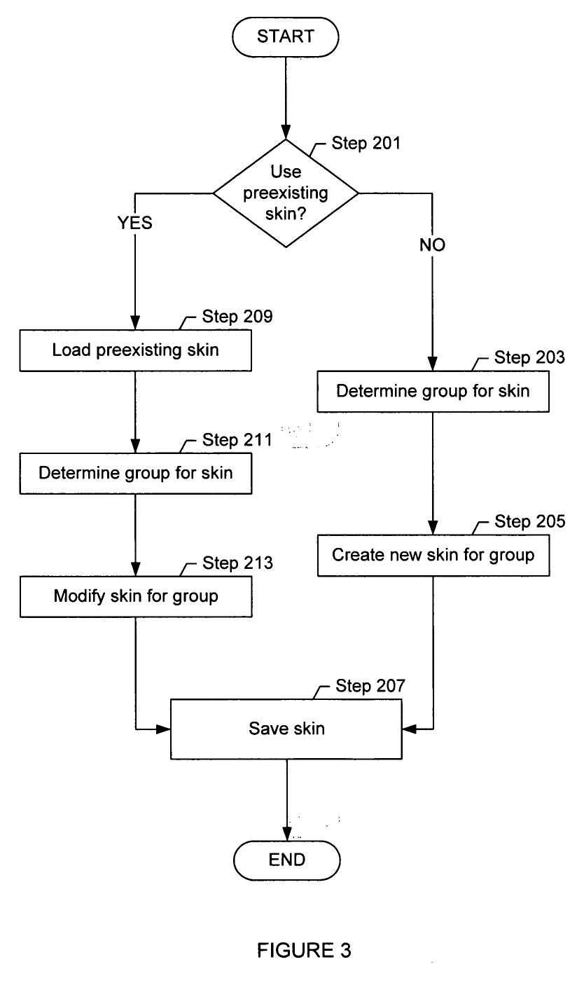

FIG. 3 shows a flow diagram: of a method for creating a skin for user interface customization in a portal server in accordance with one or more embodiments of the invention. Specifically, FIG. 3 shows a method for a user (e.g., an administrator, etc.) to create a skin for a group of users. Initially, a determination is made whether the new skin should be based on a pre-existing skin (Step 201). The administrator may decide to create a skin using another skin as a basis or may decide to create an entirely new skin.

If a new skin is to be created without using a pre-existing skin, then the administrator determines the group of users for the skin (Step 203). The administrator may base the skin design on knowledge about the group of users. For example, the administrator may use knowledge about the relevant information in the portal server to a particular group of users, the technical abilities of the group of users, or any other such knowledge.

After determining the group of users for the skin, a new skin for the group of users is created (Step 205). Specifically, web files and image files are created using knowledge about the group. For example, when designing a skin for the group corresponding to human resources, the skin may include access in the form of an image of a book linking to an employee directory in the center of the desktop. Alternatively, for example, when designing a skin for a group of code developers, the access to the employee directory may be in the corner as part of a menu bar and links to code reference manuals may be placed in the center. In accordance with one or more embodiments of the invention, functionality does not change between skins. In the above example, both the human resources and the developers have access to the employment directory.

After creating the new skin for the group, the skin is saved (Step 207). In one or more embodiments of the invention, the storage location of the skin with the skin files is a directory specific to the group. Alternatively, the skin may be saved in a mass storage region with other skin files from other groups. In the alternative, a link (e.g., pointer, group identifier, skin identifier, etc.) between the skin and the group may be added to an attribute associated with the skin and/or group.

Alternatively, if a pre-existing skin is to be used as a basis for the new skin, then the pre-existing skin is loaded (Step 209). Specifically, the administrator is given access to the pre-existing skin files. Loading the pre-existing skin files may include obtaining all or only a part of the pre-existing skin files from memory. Further, the administrator may be given full read/write/modify privileges to the pre-existing skin files or only a copy of the files may be obtained from memory.

Next, the group for the skin is determined (Step 211). By determining the group for the skin, an administrator is able to modify the skin slightly for each different group.

After determining the skin for the group, then the skin files are modified for the group (Step 213). Specifically, the administrator may open different skin files and change the formatting in the case of a web file or may change the image in the case of an image file. Alternatively, such tasks may be automated for the administrator.

Once the skin files are modified, then the skin files are saved (Step 207). Saving modified skin files may be performed in a similar manner to saving new skin files.

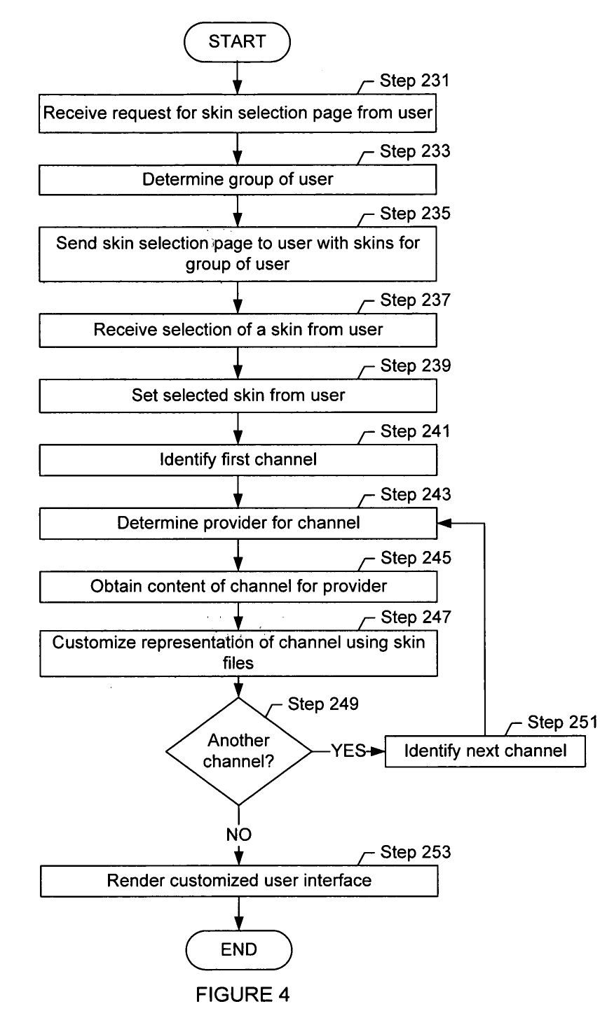

Accordingly, once the different skin files are saved and associated with a group, the skin may be changed from the user perspective. Specifically, a user can customize user interface in the portal server. FIG. 4 shows a flow diagram of a method for user interface customization in a portal server in accordance with one or more embodiments of the invention. In particular, FIG. 4 shows the background processing for the user interface customization.

Initially, a request is received from a user for the skin selection page (Step 231). Specifically, in accordance with one or more embodiments of the invention, the user may type in the uniform resource identifier (URI) of the skin selection page or click on a link associated with the skin selection page.

Next, the group of the user is determined (Step 233). The group of the user may be determined using virtually any technique known in the art, such as accessing a directory server, viewing an attribute associated with the user, or requesting the group information from the user.

Once the group of the user is determined, then the skin selection page with the skins for the group of the user is sent to the user (Step 235). Specifically, the skins for the group are determined: by accessing a directory associated with the group, following links associated with the group, or performing virtually any other similar technique. The skins for the group are then used to populate the skin selection page. At this stage, either an identifier associated with each skin may be displayed, or a graphical image of the skin may be displayed. Further, creating the skin selection page may be performed, for example, by the skin container component.

Next, a selection of the skin is received from the user (Step 239). Specifically, the user may choose the skin from a drop down menu, click on a button associated with the skin, click on a radio icon, or perform virtually any other technique for sending a selection to a backend.

After receiving the selection of the skin, the selected skin is set (Step 239). Specifically, in one or more embodiments of the invention, any attribute value, such as those found in a database or directory server, that identifies the skin used for a user is changed to identify the selected skin.

In addition, the user interface is changed to reflect the selected skin. Specifically, the first channel is identified (Step 241). The first channel may be obtained from one of the web files associated with the skin. When executing at least one web file, in one or more embodiments of the invention, the web file identifies a channel and a provider for the channel. Accordingly, next the provider for the channel is determined (Step 243).

After determining the provider for the channel, the content for the provider is obtained (Step 245). The content for the channel may be obtained by querying the provider, creating a link to a website associated with the provider, or using a script to scan a website associated with the provider. Further, in one or more embodiments of the invention, the content is obtained as a provider context object.

Once the content of the channel is obtained, then the content of the channel is customized by using the skin files (Step 247). Specifically, in one or more embodiments of the invention, the web files create a mapping between the content and the output of the content. More specifically, if the content obtained is an object, then the web files specify how information contained within specific parts of the provider context object are to be outputted, such as whether a particular font style is to be used to output text of the content, image file is to be used to represent the content, etc. Further, the web files may specify a position of content within a channel, such as a favorite stock quote in the center of the channel.

After content for the first channel is customized, then a determination is made whether another channel exists (Step 249). If another channel exists that needs to be customized, then the next channel is identified (Step 251). The process of customizing the content repeats for the next channel.

Those skilled in the art will appreciate that at any stage of customizing the user interface, the banners, menu bars, backgrounds, and all other such elements outside of the channels may be customized using the skin files.

Alternatively, once the content of all of the channels has been customized, then the customized user interface is rendered (Step 253). Rendering the customized user interface includes sending the user interface to the screen of the user.

Accordingly, after the user interface is rendered, the user is able to interact with a customized user interface. Specifically, the user may view the content from a channel provider through a different skin. Further, in one or more embodiments of the invention, the channels may be repositioned by using the web files associated with the selected skin.

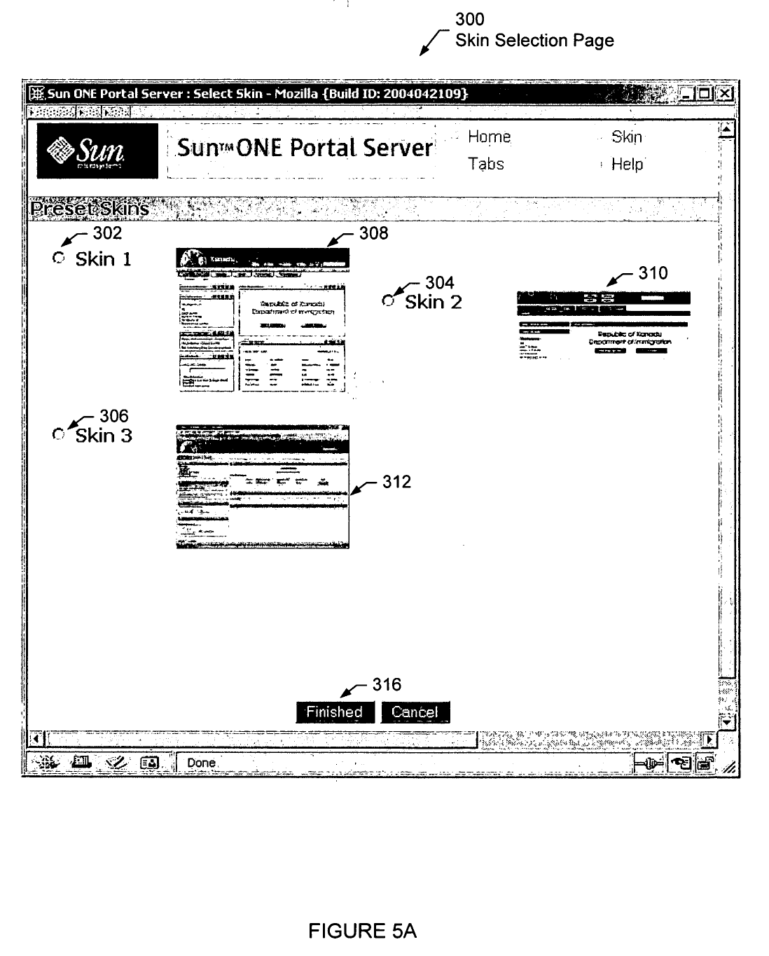

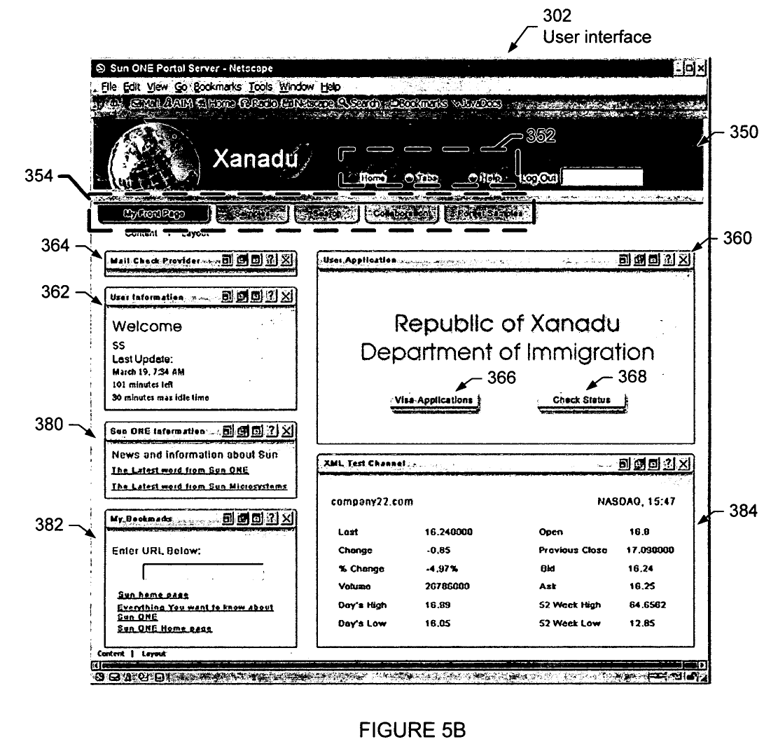

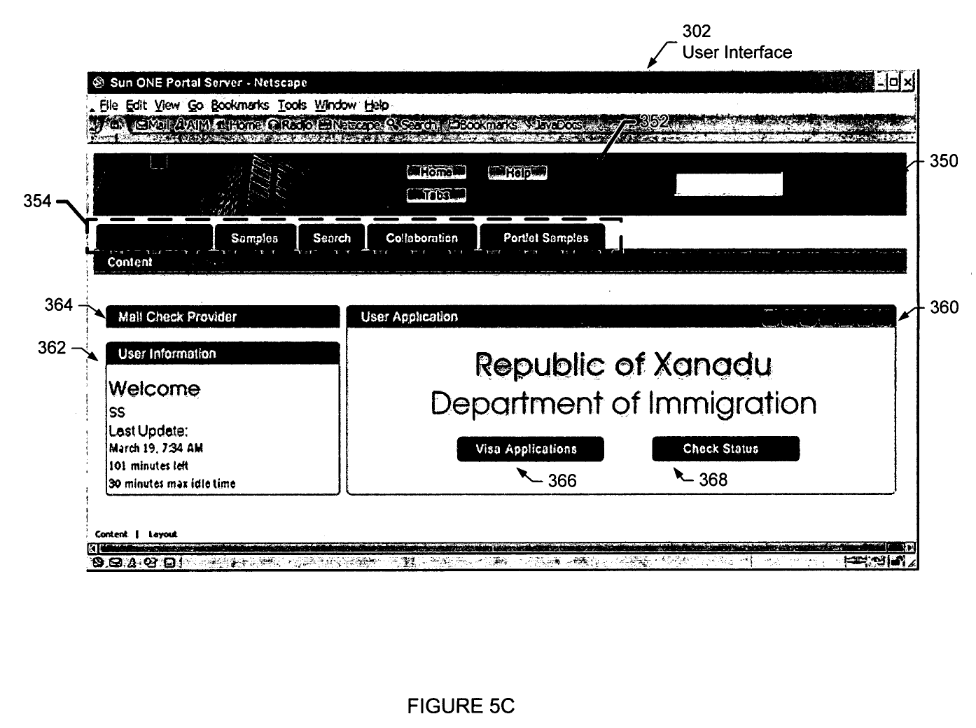

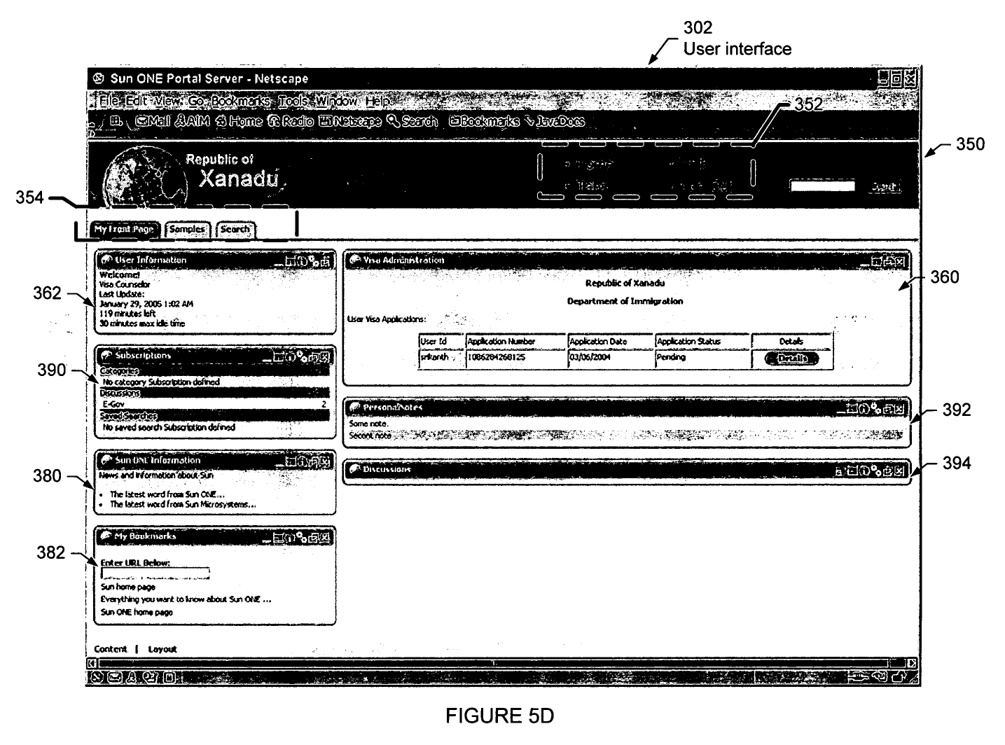

FIGS. 5A-5D show examples of user interface customization in a portal server in accordance with one or more embodiments of the invention. For the following example, consider the case when a user is accessing a Sun One Portal Server. FIG. 5A shows an example screenshot of a skin selection page (300). In the example, the user belongs to a group that includes only three skins. The user may view the various skin icons (e.g., skin 1 icon (308), skin 2 icon (310), skin 3 icon (312)) and select one of the three skins to use. Specifically, the user may click on a radio button (e.g., skin 1 radio button (302), skin 2 radio button (304), skin 3 radio button (306)) for the skin. After making the selection, the user may click on the finished button (316) in order to view the customized user interface. As soon as the user clicks on the finished button, the customized user interface is created.

FIG. 5B shows a customized user interface (302) when skin 1 is chosen. As shown in FIG. 5B, the menu bar (350) has a globe based icon and the word “Xanadu” in large letters. Further, the links to “home”, “tabs”, and “help” are in bubble letters surrounded by ovals. Also shown in FIG. 5B are multiple tabs (354). The tabs (354) in the skin 1 hang down from the menu bar.

Additionally, as shown in FIG. 5B, the skin 1 includes content from a channel labeled user application (360), content from a stock quote channel (384), content from a bookmark channel (382), content from a Sun ONE information center (380), content containing user information (362), and content from a mail check provider (364). As shown in FIG. 5B, content from the provider for user application (360) has been limited to a title and two buttons (e.g., visa application (366), check status (368)).

FIG. 5C shows a customized user interface (302) when skin 2 is chosen. As shown in FIG. 5C, the menu bar (350) has a different icon than a globe and the word “Xanadu” is removed from skin 1. Further, the links to “home”, “tabs”, and “help” are buttons rather than links in text (as shown in FIG. 5A). In addition, the tabs (354) in skin 2 appear on top of a content bar.

Additionally, as shown in FIG. 5B, the skin 2 only includes content from a channel labeled user application (360), content containing user information (362), and content from a mail check provider (364). Accordingly, the web files for the skin 2 have a different position for the channels than the web files for skin 1 (shown in FIG. 5B). In the content from the provider for user application (360), the images for the two buttons (e.g., visa application (366), check status (368)) are different from skin 1 (shown in FIG. 5B).

FIG. 5D shows an example customized user interface (302) when skin 3 is chosen. As shown in FIG. 5D, the menu bar (350) has a globe based icon and the word “Republic of Xanadu” in small letters. Further, the links to “home”, “tabs”, and “help” are in block letter rather than bubble letters shown of skin 1 (shown in FIG. 5B). Further, the links are in a different position in skin 3 from skin 1 (shown in FIG. 5B) and skin 2 (shown in FIG. 5C). In addition, the tabs (354) in the skin 3 are on top of a simple straight bar.

Additionally, as shown in FIG. 5D, the label user application of skin 1 (shown in FIG. 5B) is now changed to Visa Administration. Further, the content of the channel is different from skin 1 and skin 2. Specifically, skin 3 includes content from a bookmark channel (382), content from a Sun ONE information center (380), content containing user information (362), content from a subscription service provider (364), a discussion board channel (394) and a personal notes channel (392).

As shown in the example FIGS. 5B-5D, each of the different skins (i.e., skin 1, skin 2, skin 3) use different images for buttons and different positions the for the channels and the content within the channels. Accordingly, by changing the skin, a user is able to change the way in which a user interacts with the portal server.

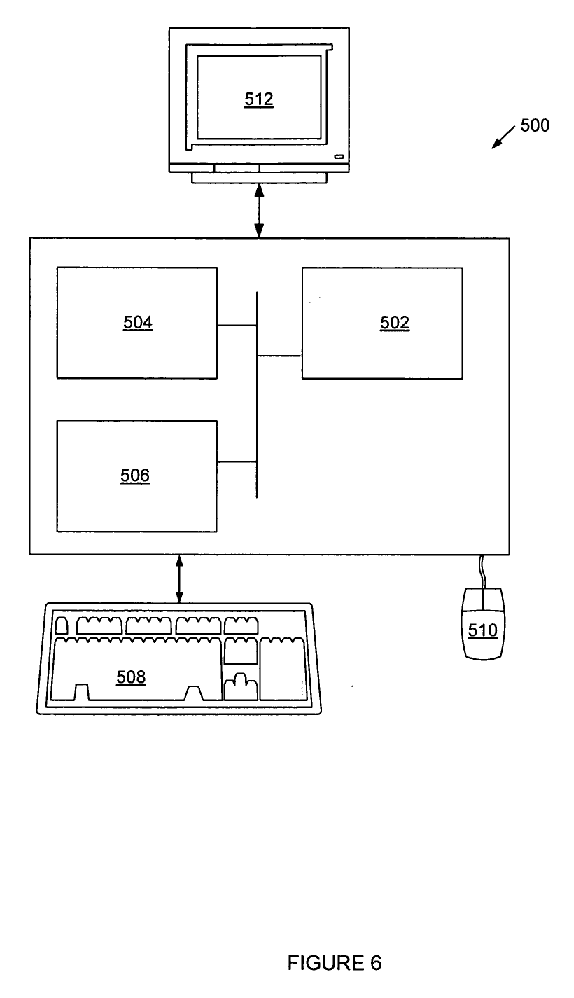

The invention may be implemented on virtually any type of computer regardless of the platform being used. For example, as shown in FIG. 6, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., single container provider, renderer, provider context, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention provide a mechanism wherein a user is able to customize the interaction with a portal server. Specifically, embodiments of the invention provide a mechanism whereby not only is the background and font color changed, but also the different images and the positioning of information is changed.

Further, embodiments of the invention provide a mechanism whereby an administrator can create customized user interfaces for specific groups. By creating customized user interfaces for different groups, users in the different groups may view only skins pertinent to the group. Specifically, functionality provided by the providers may be located in a position according to relevance. For example, the employee directory can be in a prominent position for human resource personnel and in the background for an application developer.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for user interface customization in a portal server comprising:
receiving a selection of a skin, wherein the skin comprises a plurality of files;
customizing representation of content in each of a plurality of channels by using the plurality of files to obtain a customized user interface, wherein the content in each of the plurality of channels is obtained by the portal server; and
outputting the customized user interface of the portal server.

2. The method of claim 1, wherein the plurality of files comprises web files.

3. The method of claim 2, further comprising:
repositioning the plurality of channels in the customized user interface using the plurality of web files.

4. The method of claim 1, further comprising:
determining a group associated with a user, wherein the selection of the skin is received from the user; and
displaying a plurality of optional skins to the user according to the group, wherein the selection of the skin is selected from the plurality of optional skins.

5. The method of claim 1, wherein the plurality of files comprises a plurality of image files.

6. The method of claim 4, wherein customizing representation of content comprises:
obtaining a channel of the plurality of channels;
obtaining content for the channel from a channel provider, wherein the content comprises at least one image; and
replacing the at least one image from the content using the plurality of image files.

7. The method of claim 1, further comprising:
identifying a group;
creating the skin for the group; and
adding the skin to a directory, wherein the directory is only associated with the group.

8. The method of claim 1, wherein the portal server is a Java Portal Server.

9. A computer usable medium having computer readable program code embodied therein for causing a computer system to execute a method for user interface customization in a portal server comprising:
receiving a selection of a skin, wherein the skin comprises a plurality of files;
customizing representation of content in each of a plurality of channels by using the plurality of files to obtain a customized user interface, wherein the content in each of the plurality of channels is obtained by the portal server; and
outputting the customized user interface of the portal server.

10. The computer usable medium of claim 9, wherein the plurality of files comprises web files.

11. The computer usable medium of claim 10, wherein the method further comprises repositioning the plurality of channels in the customized user interface using the plurality of web files.

12. The computer usable medium of claim 9, wherein the method further comprises:
determining a group associated with a user, wherein the selection of the skin is received from the user; and
displaying a plurality of optional skins to the user according to the group, wherein the selection of the skin is selected from the plurality of optional skins.

13. The computer usable medium of claim 9, wherein the plurality of files comprises a plurality of image files.

14. The computer usable medium of claim 13, wherein customizing representation of content comprises:
obtaining a channel of the plurality of channels;
obtaining content for the channel from a channel provider, wherein the content comprises at least one image; and
replacing the at least one image from the content using the plurality of image files.

15. The computer usable medium of claim 9, wherein the method further comprises:
identifying a group;
creating the skin for the group; and
adding the skin to a directory, wherein the directory is only associated with the group.

16. The computer usable medium of claim 9, wherein the portal server is a Java Portal Server.

17. A system for user interface customization in a portal server comprising:
a skin framework configured to:
receive a selection of a skin, wherein the skin comprises a plurality of files; and
customize representation of content in each of a plurality of channels by using the plurality of files to obtain a customized user interface, wherein the content in each of the plurality of channels is obtained by the portal server; and
a renderer configured to:
output the customized user interface of the portal server.

18. The system of claim 17, wherein the skin framework is further configured to:
determining a group associated with a user, wherein the selection of the skin is received from the user; and
displaying a plurality of optional skins to the user according to the group, wherein the selection of the skin is selected from the plurality of optional skins.

19. The system of claim 13, wherein customizing representation of content comprises:
obtaining a channel of the plurality of channels;
obtaining content for the channel from a channel provider, wherein the content comprises at least one image; and
replacing the at least one image from the content using the plurality of image files.

20. The system of claim 17, wherein the portal server is a Java Portal Server.
